(19) United States
(12) Patent Application Publication
(10) Pub. No.: US 2025/0026609 A1
(43) Pub. Date: Jan. 23, 2025

(54) ELEVATOR SYSTEM AND A METHOD

(71) Applicant: KONE Corporation, Helsinki (FI)

(72) Inventors: Ari JUSSILA, Helsinki (FI); Toni HIRVONEN, Helsinki (FI); Atso KOSKINEN, Helsinki (FI)

(73) Assignee: KONE Corporation, Helsinki (FI)

(21) Appl. No.: 18/908,182

(22) Filed: Oct. 7, 2024

Related U.S. Application Data
(63) Continuation of application No. PCT/EP2022/059505, filed on Apr. 8, 2022.

(51) Int. Cl. B66B 1/34; B66B 1/28; B66B 3/02

(52) U.S. Cl. CPC B66B 1/3492; B66B 1/28; B66B 3/02

(57) ABSTRACT

An elevator system includes an elevator car, a hoistway with landing doors, a first sensor system generating position information indicating a position of the elevator car in the hoistway, a second sensor system generating position information indicating a position of the elevator car in the hoistway, and a hoisting machine moving the elevator car during elevator runs between the landing doors based on position information generated by the first and second sensor system. In case the elevator system detects that one of the first and second sensor systems has a fault, the elevator system is configured to control the hoisting machine to continue an elevator run to a landing door, if positioning data from the first or second sensor system for which no fault has been detected is available. This reduces the risk of entrapment for the passengers.

### BACKGROUND OF THE INVENTION

### Field of the Invention

This invention relates to an elevator system and more particularly to a solution for securely operating an elevator system during a fault condition.

### Description of Prior Art

Previously there is known an elevator system with a hoisting machine moving an elevator car between landing doors during elevator runs. In order to be able to move the elevator correctly as desired by the passengers, it is necessary for the elevator system to have available positioning information indicating the position of the elevator car in the hoistway.

In the known elevator system, a first and a second sensor system are used to provide the elevator system with positioning information. Use of two different systems increases the safety, by avoiding that a fault in a single sensor, for instance, could be unnoticed and cause problems during an elevator run. Consequently, the positioning information from the first and second sensor system can be continuously monitored to ensure that the elevator system operates as intended.

A problem with this known solution is, however, that when a fault is detected in one of the first and second sensor systems, emergency braking is triggered. Due to this the elevator run ends at the location where the elevator car happens to be located when the fault is detected. A result of this is that the passengers are trapped inside the elevator car, and maintenance personnel are urgently needed at the elevator site in order to get the passengers out of the elevator car.

### SUMMARY OF THE INVENTION

An object of the present invention is to solve the above-mentioned drawback. This object is achieved with the elevator system according to in independent claim 1 and the method according to independent claim 9.

When a hoisting machine is controlled to continue an elevator run in a situation where a fault is detected by utilizing positioning information from the first or second sensor system for which no fault has been detected, the elevator car can be moved to a landing door from where the passengers may leave the elevator car without any additional safety risks. In this way entrapment of passengers may be avoided.

Preferred embodiments of the invention are disclosed in the dependent claims.

### BRIEF DESCRIPTION OF DRAWINGS

In the following the present invention will be described in closer detail by way of example and with reference to the attached drawing, in which

FIG. 1 is a block diagram of an elevator system.

### DESCRIPTION OF AT LEAST ONE EMBODIMENT

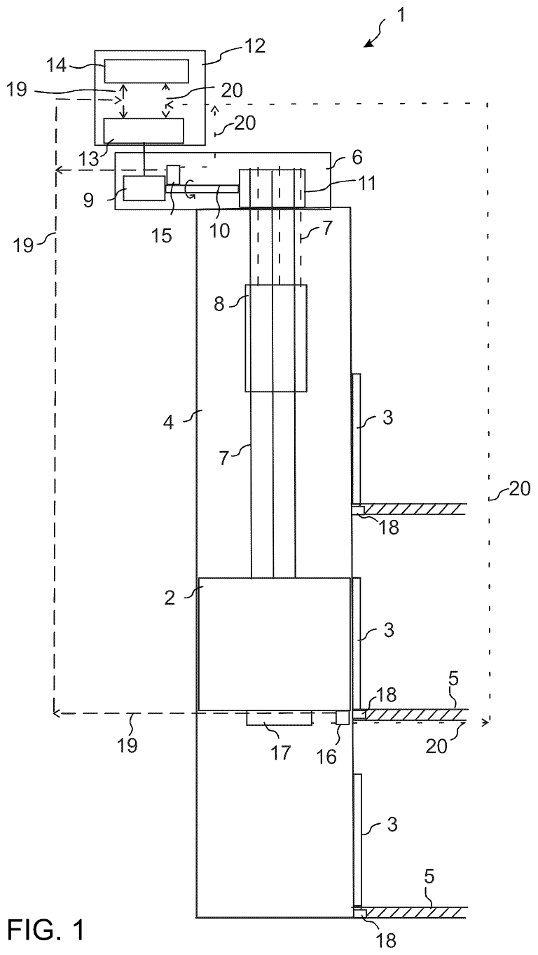

FIG. 1 illustrates a simplified illustration of an elevator system 1 where a method for operating an elevator system can be implemented.

In FIG. 1, an elevator car 2 is moved in a hoistway 4 between landing doors 3 which are located on different floors 5 of a building, for instance. In the illustrated example the elevator car 2 is moved by a hoisting machine 6 by means of ropes 7. The same ropes are also used to move a counterweight 8 in the hoistway 4.

The hoisting machine 6 comprises an electric motor 9 which via a shaft 10 drives sheave 11 around which the ropes 7 run. In the illustrated example the operation of the elevator system is controlled by a control system 12 comprising one or more components. These components may be arranged in a single device cabinet as illustrated by way of example, or alternatively distributed at different locations around the elevator installation site. The illustrated control system may be implemented by electrical circuits, by one or more processors running a program code or as a combination of these, for instance.

In FIG. 1 the electric motor 9 of the hoisting machine 6 is controlled by a motion controller 13, which may include a plurality of components, including a frequency converter supplying electric power to the electric motor 9. Additionally, in the illustrated example of FIG. 1, the control system 12 comprises a main safety circuit 14, which may be implemented as a programmable electronic controller running a safety monitoring software monitoring the operation of the entire elevator system, for instance. The main safety circuit 14 may receive signals from a plurality of components in the elevator system 1 and it may control an electromechanical brake of the hoisting machine and emergency brakes, for instance, in order to be able to initiate emergency braking when needed.

In order to be able to move the elevator car 2 correctly in the hoistway 4 during elevator runs, the control system 12, such as the motion controller 13, needs positioning information of the elevator car 2 in the hoistway 4. Such positioning information is provided by a first sensor system and a second sensor system, which are independent of each other. In FIG. 1 three different sensor systems 15, 16 and 17 are illustrated. In some implementations they may all be simultaneously present and in use, however, in other implementations it is sufficient if only two sensor systems are present and in use.

In FIG. 1 it is by way of example assumed that one of the sensor systems comprises a motor encoder 15 of the hoisting machine 6. Such an encoder may be integrated into the electric motor, or it may be arranged to monitor a shaft 10 between the electric motor and the sheave 11, for instance, as illustrated by way of example in FIG. 1. In this way the motor encoder 15 is adapted to measure rotation of the elevator hoisting machine 6. Speed feedback from the motor encoder 15 to the motion controller 13 is used for speed control of elevator car 2, however, the motion controller 13 can also use the information from the motor encoder to track the position of the elevator car in the hoistway.

In FIG. 1 another one of the sensor systems comprises a door zone sensor 16 providing positioning information indicating when the elevator car is located at a landing door 3. In the illustrated example it has been assumed that a magnet 18 has been provided at the location of each door 3 zone. Consequently, the sensor 16, which in the illustrated example is located at the bottom of the elevator car 2, is able to detect the magnet and provide an absolutely exact indication of when the elevator car is located at a door 3 zone. This gives the motion controller 13 of the elevator system 1 information of when to stop the elevator such that it is correctly aligned with the floor 5 of the landing.

Finally, in FIG. 1 another one of the sensor systems comprises an absolute position measurement device 17 providing information indicating the absolute position of the elevator car 2 in the hoistway 4. In the illustrated example it is assumed that the measurement device 17 is an encoder mounted to a rope pulley below the elevator car 2. As the elevator car moves, the rope 7 moves at the pulley, due to which the pulley rotates. The encoder can detect this due to marks on the pulley, in particular on a magnetic ring mounted to the pulley, and based on this the amount of rotation, and also the amount of movement of the elevator car can be calculated such that the motion controller 13 can keep track of the position of the elevator car 2.

An alternative way of implementing an absolute position measurement device 17 is to provide a strip of markings along the entire height of a vertical wall or a vertical bar in the hoistway 4. In that way, a camera mounted on top of the elevator car 2 may be used to continuously read markings on this strip while the elevator car moves and based on the readings, the motion controller 13 can keep track of the absolute position of the elevator car 2 in the hoistway 4.

In the illustrated elevator system 1 two communication paths 19, 20 (or channels) are provided. All of the sensor devices 15, 16, 17 use both of these two communication paths to provide positioning information to other parts of the elevator system, and in particular to the control system 12 and the motion controller 13. Consequently, the communication paths are doubled and a fault in one of them does not prevent the other one from forwarding information from each of the sensor devices 15, 16, 17 to other parts of the elevator system. In praxis, the communication paths 19, 20 may be implemented by electrical or optical wires, wireless communication connections or combinations of these.

In case a fault occurs in one of the sensor devices 15, 16, 17 or in the communication paths 19, 20, such that the hoisting machine 6 can no longer move the elevator car based on position information from both the first and second sensor system, the elevator system 1, or more particularly in the illustrated example, the main safety circuit 14 detects the situation. Such a situation may occur when the motion controller 13 has available positioning information from only one of the first and second sensor system, or when the positioning data from the first and second sensor systems does not match.

If the safety circuit 14 of the elevator system 1 can determine which one of the first and second sensor systems has a fault and that the other one has no fault, the safety circuit 14 allows drive with the hoisting machine 6 to continue the elevator run to a landing door 3 by using positioning information from only the first or second sensor system for which no fault has been detected. In this way the elevator run can continue, possibly with a minimum elevator speed, to a position where passengers in the elevator can leave the elevator. In the illustrated example where three sensor systems are provided, naturally the elevator run may continue also if no fault has been detected for two of the sensor systems and only one sensor system has a fault.

If the safety circuit 14 determines that the elevator run may continue, it is possible that the elevator run continues in the same direction without any interruptions. Alternatively, it is possible that the safety circuit momentarily stops the elevator car for a more thorough fault analysis when a fault is detected, and after this, allows the elevator run to continue in the same or in the opposite direction. Once the next landing door 3 is reached and the passengers can leave the elevator car 2, the safety circuit may block further use of the elevator car in question, until maintenance personnel has visited the elevator site.

However, if the safety circuit 14 is not able to determine and identify with certainty that one of the first or second sensor systems has no fault and can safely be used as a basis for the continued elevator ride, the safety circuit 14 initiates braking to stop movement of the elevator car. Only this alternative involves entrapment of the passengers and requires urgent assistance by maintenance personnel on the installation site.

Naturally, in case the safety circuit 14 detects that the positioning information from one of the first and second sensor systems is not available for the motion controller 13, the safety system can identify that this one is the faulty sensor system, and allow a continued ride by using the other one of the sensor systems. Also, in case of an elevator system involving three different sensor systems, as illustrated in FIG. 1, it is possible to determine which one of the sensor systems is faulty when the positioning information from one of the systems does not match with the positioning information from the two other sensor systems. Consequently, with the explained solution, the risk of entrapment for passengers can be significantly reduced as compared to previously known elevator systems.

It is to be understood that the above description and the accompanying FIGURES are only intended to illustrate the present invention. It will be obvious to a person skilled in the art that the invention can be varied and modified without departing from the scope of the invention.

1. An elevator system comprising:
an elevator car;
a hoistway with landing doors;
a first sensor system generating position information indicating a position of the elevator car in the hoistway, the first sensor system comprising a door zone sensor providing positioning information indicating that the elevator car is located at a landing door;
a second sensor system generating position information indicating a position of the elevator car in the hoistway, the second sensor system comprising an absolute position measurement device providing positioning information indicating the absolute position of the elevator car in the hoistway; and
a hoisting machine moving the elevator car during elevator runs between the landing doors based on position information generated by the first and second sensor system,
wherein, in case the elevator system detects that one of the first and second sensor systems has a fault such that information indicating when the elevator is located at a landing door or information indicating the absolute position of the elevator car in the hoistway is missing, and the elevator system can determine which one of the first and second sensor systems has the fault, the elevator system is configured to control the hoisting machine to continue an elevator run to a landing door, if positioning data from the first or second sensor system for which no fault has been detected is available.

2. The elevator system according to claim 1, wherein the elevator system is configured to stop the elevator car immediately in case the elevator system can not verify that positioning data from the first or second sensor system for which no fault has been detected is available.

3. The elevator system according to claim 1, where the first and second sensor system comprises sensor devices providing position information and communication paths forwarding the positioning information to other parts of the elevator system.

4. The elevator system according to claim 3, wherein the communication paths from the sensor devices of the first and second sensor system to other parts of the elevator system are doubled to provide two parallel independent communication paths.

5. The elevator system according to claim 1, wherein the elevator system is configured to control the hoisting machine to continue an elevator run with a minimum elevator car speed.

6. The elevator system according to claim 1, wherein the second sensor system comprises a motor encoder providing positioning information based on rotation of the hoisting machine.

7. The elevator system according to claim 1, wherein the elevator system is configured to detect a fault when positioning information from the first and second sensor systems do not match.

8. The elevator system according to claim 1, wherein the elevator system is configured to detect a fault when positioning information from one of the first and second sensor systems is not available for a motion controller of the elevator system which controls the hoisting machine.

9. A method for operating an elevator system, comprising the steps of:
obtaining positioning information indicating a position of an elevator car in a hoistway from a first sensor system comprising a door zone sensor providing positioning information indicating that the elevator car is located at a landing door;
obtaining positioning information indicating a position of an elevator car in a hoistway from a second sensor system comprising an absolute position measurement device providing positioning information indicating the absolute position of the elevator car in the hoistway;
monitoring positioning information from the first and second sensor system to detect a fault in one of the first and second sensor systems; and
controlling the hoisting machine to continue an elevator run to a landing door when a fault is detected due to information indicating when the elevator is located at a landing door or information indicating the absolute position of the elevator car in the hoistway is missing, if it can be determined which one of the first and second sensor systems has the fault, and if positioning information from the first or second sensor system for which no fault has been detected is available, and otherwise stopping movement of the elevator car.

10. The elevator system according to claim 2, where the first and second sensor system comprises sensor devices providing position information and communication paths forwarding the positioning information to other parts of the elevator system.

11. The elevator system according to claim 2, wherein the elevator system is configured to control the hoisting machine to continue an elevator run with a minimum elevator car speed.

12. The elevator system according to claim 3, wherein the elevator system is configured to control the hoisting machine to continue an elevator run with a minimum elevator car speed.

13. The elevator system according to claim 4, wherein the elevator system is configured to control the hoisting machine to continue an elevator run with a minimum elevator car speed.

14. The elevator system according to claim 2, wherein the second sensor system comprises a motor encoder providing positioning information based on rotation of the hoisting machine.

15. The elevator system according to claim 3, wherein the second sensor system comprises a motor encoder providing positioning information based on rotation of the hoisting machine.

16. The elevator system according to claim 4, wherein the second sensor system comprises a motor encoder providing positioning information based on rotation of the hoisting machine.

17. The elevator system according to claim 5, wherein the second sensor system comprises a motor encoder providing positioning information based on rotation of the hoisting machine.

18. The elevator system according to claim 2, wherein the elevator system is configured to detect a fault when positioning information from the first and second sensor systems do not match.

19. The elevator system according to claim 3, wherein the elevator system is configured to detect a fault when positioning information from the first and second sensor systems do not match.

20. The elevator system according to claim 4, wherein the elevator system is configured to detect a fault when positioning information from the first and second sensor systems do not match.
